(19) United States
(12) Patent Application Publication
(10) Pub. No.: US 2006/0072994 A1
(43) Pub. Date: Apr. 6, 2006

(54) Apparatus and system for storing and transporting material

(76) Inventor: Kimberly E. Noding, Scottsdale, AZ (US)

Correspondence Address: TOD R. NISSLE, P.C., P.O. Box 55630, Phoenix, AZ, 85078, US

(21) Appl. No.: 10/957,360

(22) Filed: Oct. 1, 2004

(51) Int. Cl. B60P 9/00

(52) U.S. Cl. 414/462

(57) ABSTRACT

Improvements are provided for storing and transporting material in the bed of a pickup truck. The material is stored in a canted orientation in a configuration that utilizes the existing bed of the truck to secure the material for transport.

This invention pertains to an apparatus and system for storing and transporting material.

More particularly, this invention pertains to an apparatus and method for storing and transporting material in the bed of a truck.

In a further respect, the invention pertains to a method and apparatus for storing material in a canted orientation in the bed of a truck and for securing the material for transport by the truck.

In another respect, the invention pertains to an apparatus for storing stacks of material of varying thickness and width in the bed of a truck.

In still another respect, the invention pertains to a rack apparatus that utilizes the wheel wells in the bed of a truck to anchor and support the rack to transport material in the truck.

In still a further respect, the invention pertains to a rack apparatus that permits plywood panels, wood beams, sheets of paneling, and other elongate pieces of material stored in the bed of a pickup truck to extend into and utilize the space above the cab of the truck while preventing the material from contacting the roof of the truck cab.

A wide variety of storage racks for pickup and other trucks are known. For example, utility trucks are often provided with racks that permit tubing and other construction materials to be stored in a horizontal orientation. Such racks often are mounted or secured to the floor or to the corners or upper lips or edges of the bed of the pickup truck. Securing a rack to the wall of the truck bed typically is undesirable because the wall is not sufficiently strong or because unsightly holes must be drilled through the wall to receive bolts used to secure the rack to the wall. Another disadvantage of existing racks is that they normally require a two or more primary structural components in order to support material in a horizontal orientation. One of the structural components is positioned in the front or to one side of the bed while the other structural component is positioned at the rear or to the other side of the truck bed. A further disadvantage of many existing racks is that they do not provide a means for securing material to the rack. Tie downs, rope, or other fastening means must be provided. Still another disadvantage of existing racks is that they do not readily permit oversized material to be stored on the racks, which material extends laterally past the sides of the racks. Still a further disadvantage of existing racks is that they do not utilize the existing truck bed to assist in securing material in place in the truck bed.

Accordingly, it would be highly desirable to provide an improved pickup truck bed material storage and transportation apparatus and system for storing and transporting material.

Therefore, it is a principal object of the instant invention to provide an improved apparatus and system for storing and transporting material.

Another object of the invention is to provide an improved apparatus and system that enable materials to be stored in a canted orientation in the bed of a pickup truck.

A further object of the invention is to provide a material storage and transport apparatus that can be anchored in the bed of a pickup truck without requiring that the apparatus be secured to the corners or sides of the truck bed.

Still another object of the invention is to provide a material storage apparatus and system that requires the use of only a single primary auxiliary support structure.

Still a further object of the invention is to provide an improved material storage and transport apparatus that does not require the use of rope or tie-downs to secure the material in place on the apparatus.

Yet another object of the invention is to provide an improved material storage and transport system that utilizes the existing truck bed to assist in securing material in place in the truck bed.

These and other, further and more specific objects and advantages of the invention will be apparent from the following detailed description of the invention, taken in conjunction with the drawings, in which:

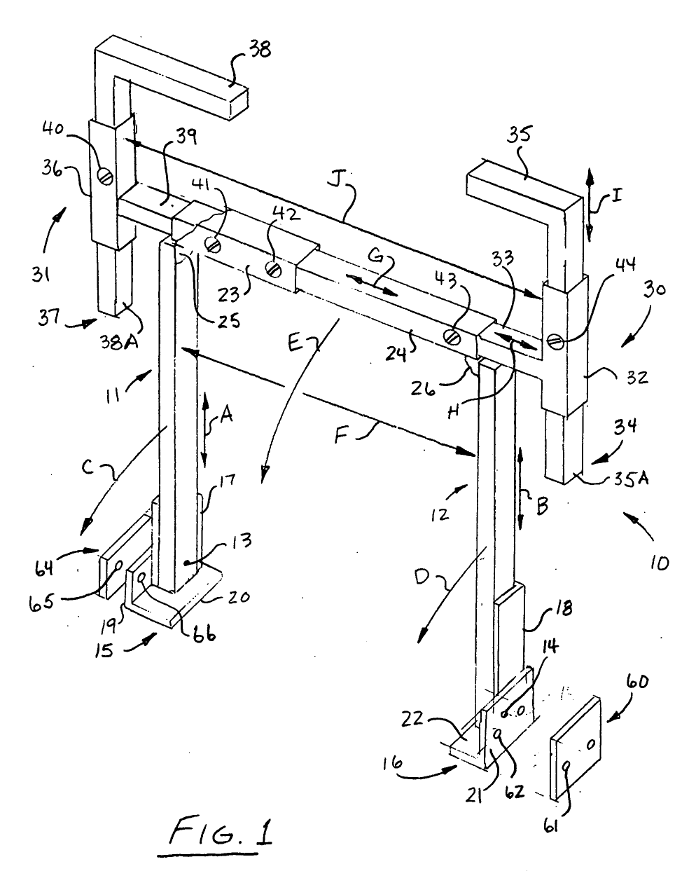

FIG. 1 is a perspective view illustrating the primary auxiliary support structure of the storage and transport apparatus and system of the invention;

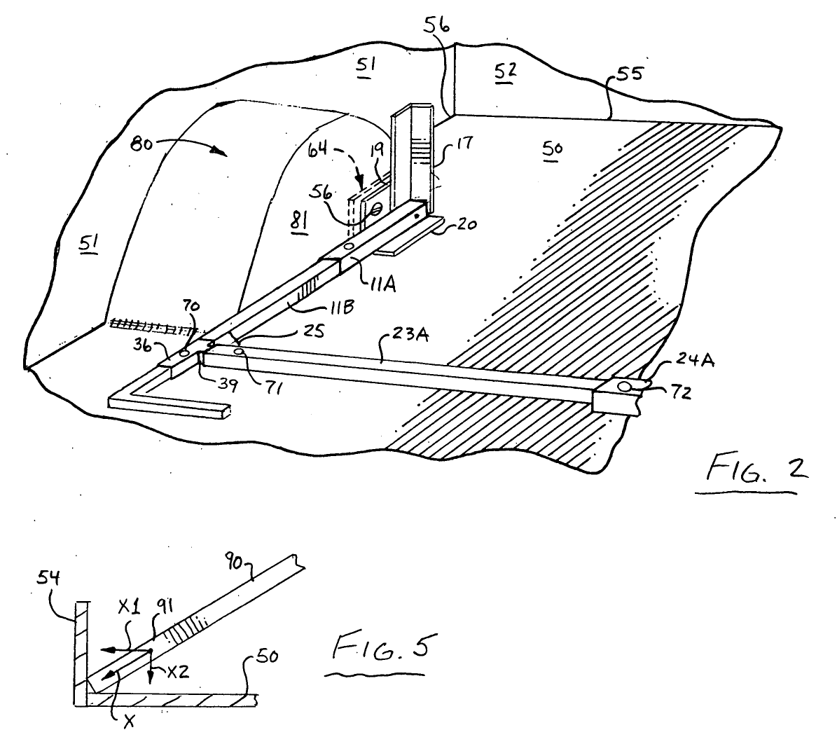

FIG. 2 is a perspective view illustrating the anchoring of one leg of the structure of FIG. 1 to a wheel well and to the floor of the bed of a pickup truck;

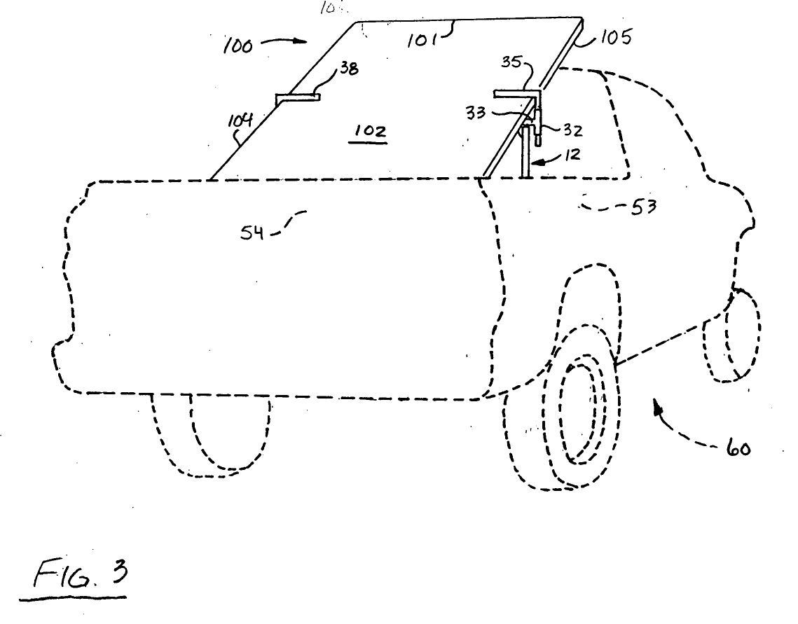

FIG. 3 is a perspective view illustrating the storage of sheet material using the apparatus and system of the invention;

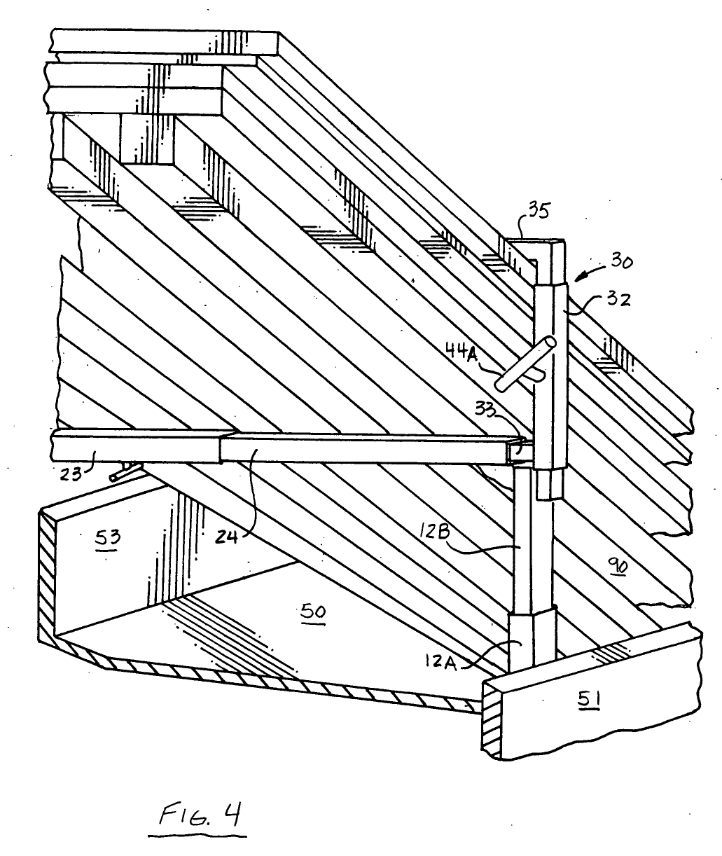

FIG. 4 is a perspective view illustrating the use of the primary auxiliary component of FIG. 1 to secure in place material mounted thereon; and,

FIG. 5 is a side elevation view illustrating the participation of the bed and tailgate of a pickup truck in mounting and securing canted panel material in the bed.

Briefly, in accordance with my invention, I provide an improved storage and transport system. The system comprises a truck. The truck includes a cab; a bed with a floor, forward wall, side walls, and an end wall, each of said walls and the floor coterminating at the floor to form a corner extending along said bed; and, wheel wells extending at least in part into the bed. The system also comprises an auxiliary support structure secured to and extending upwardly from the bed and including at least one horizontally oriented support member. The system also comprises at least one elongate piece of material extending over the horizontally oriented support member. The material has a first end and a second end and an intermediate portion extending between the first and second ends. The section of the intermediate portion contacts and is supported by the horizontally oriented support member. The support structure is shaped and dimensioned and positioned in the bed such that the first end extends over the cab; and, the second end is positioned in the corner adjacent the end wall and the floor such that the force of gravity acting on the material forces the second end against the end wall and the end wall acts to prevent the second end from moving upwardly away from the floor.

In accordance with another embodiment of the invention, I provide an improved storage and transport system. The system comprises a truck. The truck includes a cab; a bed with a floor, forward wall, side walls, and an end wall, each of the walls and the floor coterminating at the floor to form a corner extending along said bed; and at least a pair of spaced apart wheel wells extending at least in part into the bed. The system also comprises an auxiliary support structure secured to and extending upwardly from the bed and including at least one horizontally oriented support member; a pair of legs, each of the legs having a foot secured to a different one of the wheel wells; and, at least one vertically adjustable member including an arm. The system also comprises at least one elongate piece of material extending over the horizontally oriented support member. The material has a top, a bottom, a first end, a second end, and an intermediate portion extending between the first and second ends. A section of the intermediate portion contacts and is supported by the horizontally oriented support member, the arm contacting the top to secure the piece of material in place. The support structure is shaped and dimensioned and positioned in the bed such that the first end extends over the cab; and, the second end contacts the end wall.

In a further embodiment of the invention, I provide an improved storage and transport system. The system comprises a truck. The truck includes a cab; a bed with a floor, forward wall, side walls, and an end wall, each of the walls and the floor coterminating at the floor to form a corner extending along the bed, and at least a pair of spaced apart wheel wells extending at least in part into the bed. The system also comprises an auxiliary support structure secured to and extending upwardly from the bed and including at least one horizontally oriented support member adjustable to extend from one of the wheel wells to the other; at least one leg secured to the bed; and, at least one horizontally adjustable member extending laterally from the horizontally oriented support member to supplement the length of the horizontally adjustable member. The system also comprises at least one elongate piece of material extending over the horizontally oriented support member. The material has a top, a bottom, a first end, a second end, and an intermediate portion extending between the first and second ends, a section of said intermediate portion contacting and supported by the horizontally oriented support member. The arm contacts the top to secure the piece of material in place. The support structure is shaped and dimensioned and positioned in said bed such that the first end extends toward the cab; and, the second end contacts the end wall.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates an auxiliary support structure constructed in accordance with the invention and generally indicated by reference character 10. Structure 10 includes a pair of substantially rigid spaced apart legs 11 and 12. In FIG. 1, legs 11 and 12 are unitary. Legs 11 and 12 can, however, as depicted in FIGS. 2 and 4, be telescoping or otherwise constructed such that the length of each leg 11 and 12 is adjustable in the manner indicated by arrows A and B, respectively.

The lower end of leg 11 is pivotally attached by a pin 13 to upstanding member 19 of rigid foot 15. Foot 15 also includes horizontally oriented pad 20 attached to member 19 and includes upstanding L-shaped member 17. The bottom of member 17 is fixedly welded or otherwise secured to pad 20. Member 17 functions as a backstop and as a support when leg 11 is in the upright deployed position illustrated in FIG. 1. When leg 11 is in the upright position of FIG. 1, a quick release pin or any other desired fastening means can be utilized to secure the lower end of leg 11 to member 19 so that leg 11 is prevented from pivoting downwardly in the direction of arrow C away from the position of leg 11 illustrated in FIG. 1.

Panel member 64 is opposed and generally parallel to member 19 and includes openings 65 formed therethrough. Member 64 is positioned on the inside of a wheel well 80 and opposed to member 19 such that a portion of the wheel well wall 81 is sandwiched and compressed between members 19 and 64, and, such that each opening 65 in member 64 is in registration with an opening formed through member 19. Bolts 56 extend through each opening 65, through an associated opening (not visible) formed through wall 81, and through an opening formed through member 19 that is in registration with opening 65 and the associated opening formed through wall 81. Panel member 64 is important because it substantially strengthens the structural attachment of member 19 to wall 81. Bolting or otherwise securing member 20 to the floor 50 of the pickup truck bed is also important in this respect because it further secures the apparatus of the invention in the pickup truck bed. Rigid fixed member 17 further contributes to the stability of the apparatus when the apparatus is in the deployed upright orientation illustrated in FIGS. 1, 4, 5. Member 17 helps prevent the displacement of leg 11 toward the cab of the pickup truck.

The lower end of leg 12 is pivotally attached by a pin 14 to upstanding member 21 of rigid foot 16. Foot 16 also includes horizontally oriented pad 22 attached to member 21 and includes upstanding L-shaped member 18. The bottom of member 18 is fixedly welded or otherwise secured to pad 22. Member 18 functions as a backstop and as a support when leg 12 is in the upright deployed position illustrated in FIG. 1. When leg 12 is in the upright position of FIG. 1, a quick release pin or any other desired fastening means can be utilized to secure the lower end of leg 12 to member 21 so that leg 12 is prevented from pivoting downwardly in the direction of arrow D and away from the position of leg 12 illustrated in FIG. 1.

Panel member 60 is opposed and generally parallel to member 21 and includes openings 61 formed therethrough. Member 60 is positioned on the inside of a wheel well and opposed to member 21 such that a portion of the wheel well wall is sandwiched and compressed between members 21 and 60 and, such that each opening 61 in member 60 is in registration with an opening 62 formed through member 19. Bolts (not shown) extend through each opening 61, through an associated opening formed through the wheel well wall, and through an opening 62 in member 19 that is in registration with opening 65 and the associated opening formed through the wheel well wall. Panel member 60 is important because it substantially strengthens the structural attachment of member 21 to the wheel well wall. Bolting or otherwise securing member 22 to the floor 50 of the pickup truck bed is also important in this respect because it further secures the apparatus of the invention in the pickup truck bed. Rigid fixed member 18 further contributes to the stability of the apparatus when the apparatus is in the deployed upright orientation illustrated in FIGS. 1, 4, 5. Member 18 helps prevent the displacement of leg 12 toward the cab of the pickup truck.

One principal advantage of securing the apparatus of the invention to the wheel well walls is that it permit a tool box to be place in the pickup truck bed between the cab and the apparatus of the invention. Placement of the apparatus of the invention intermediate the wheel wells also normally permits the installation of a fifth wheel in the bed of the pickup truck along with the apparatus of the invention.

When the quick release pins or other means that fix legs 11, 12 in the upright position shown in FIG. 1 are removed, legs 11 and 12 (along with members 23, 24, etc. secured to the top of legs 11 and 12) can be pivoted downwardly in the direction of arrows C and D such that legs 11 and 12 lay on the floor 50 of the bed of a truck in the manner illustrated in FIG. 2. Quick release pins or other fastening means can also, if desired, be inserted through legs 11, 12 and into feet 15, 16 to secure structure 10 in the storage position of FIG. 2.

The upper end of leg 11 is welded 25 or otherwise fixedly secured to hollow rigid, fixed orthogonal member 23. Hollow, rigid, orthogonal member 24 telescopes into and out of member 23 and can be slidably displaced in the directions indicated by arrow G so that the distance F between legs 11 and 12 and the distance J between T-shaped members 30 and 31 can be adjusted. Alternatively, member 24 can slide over member 23 I the manner illustrated in FIG. 2 by members 24A, 24B.

Leg 39 of T-shaped member 31 is slidably received by member 23 (or by member 24, if desired). Hollow orthogonal member 36 of member 31 slidably receives the leg 38A of L-shaped member 37. Member 37 includes horizontally oriented securing arm 38.

Leg 33 of T-shaped member 30 is slidably received by member 24. Hollow orthogonal member 32 of member 30 slidably receives the leg 35A of L-shaped member 34. Member 34 includes horizontally oriented securing arm 35. The position of L-shaped member 34 in member 32 is vertically slidably adjustable up and down in the directions indicated by arrow 1. Similarly, the position of L-shaped member 37 in member 36 is vertically slidably adjustable up and down. Lower end 38A of member 37 is sized to slide downwardly into the hollow upper end of leg 11 (or into the upper half 11B when leg 11 has the telescoping configuration illustrated in FIG. 2) when leg 39 of member 31 is slid completely into the left hand end of member 24 illustrated in FIG. 1. FIG. 2 illustrates end 38A slidably inserted in upper half 11B. Similarly, lower end 35A of member 34 is sized to slide downwardly into the hollow upper end of leg 12 when leg 33 of member 30 is slid completely into the right hand end of member 24 illustrated in FIG. 1.

When one of the sliding members of FIG. 1 is moved to a desired position, it is releasably fixed in the desired position with a set screw, quick release pin, or other desired fastening system. For example, in FIG. 1, set screw 40 in member 36 is tightened against leg 38A to secure member 37 in position in member 36. Similarly, set screw 41 mounted in member 23 is turned against leg 39 to secure leg 39 in position; set screw 42 secures member 24 in position; and, set screw 44 secures leg 35A in position in member 32. Set screws 40 to 44 are turned with a screw driver. Set screws that can be turned by hand can be used in conjunction with or in place of set screws 40-44. For example, in FIG. 4 set screw 44A is turned by hand.

The mounting of auxiliary support structure 10 in a truck bed is described with reference to FIG. 2. Each foot 15, 16 is secured to the floor 50 and to a different one of the wheel wells of a truck 60. As is well known, a pair of spaced apart wheel wells 80 are normally found in the bed of a pickup truck. Foot 15 is, as shown in FIG. 2, bolted 56 to the wall 81 of one wheel well and preferably is also bolted or otherwise fastened to the floor 50 of the pickup truck bed. Foot 16 is similarly bolted to the wall of the other opposing wheel well in the pickup truck bed. Prior to bolting feet 15 and 16 in place, set screw 42 is loosened so that member 24 can telescope in the directions of arrows G (FIG. 1) to adjust distance F so that member 19 is contacting or adjacent vertical inner wall 81 and so that member 21 is contacting or adjacent the vertical inner wall of the other wheel well. Wall 81 is referred to as an inner wall because it faces the inside of the truck bed.

The pickup truck bed includes floor 50, side walls 51 and 53, front wall 52, and tailgate or rear wall 54. The walls 51 to 54 each coterminate with floor 50 to form a corner 55, 56 that extends-except for where the wheel wells 80 protrude into the bed-around the bottom of the bed of the truck. Some pick-up trucks have a reduced size bed that sits between the wheel wells such that the wheel wells do not extend into the bed of the truck. The auxiliary support structure of the invention can be utilized in these trucks because one side of each wheel well actually comprises a part of the wall of the bed of the truck. However, most pickup trucks include a pair of wheel wells that at least in part extend past a wall 51 of the bed and into the bed of the truck. The invention is believed particularly useful in these kinds of trucks because feet 15 and 16 are fastened directly to the wheel wells and not to the wall or walls of the bed of the truck.

In use, auxiliary support structure 10 is installed in the bed of a pickup truck in the manner earlier described with reference to FIG. 2. Legs 11 and 12 are pivoted upwardly from the storage position on floor 50 (illustrated in FIG. 2) to the deployed position illustrated in FIG. 1. Quick release pins or other securing means are used to lock the bottom portions of legs 11 and 12 to feet 15, 16, respectively, such that legs 11 and 12 are secured in the upright deployed position depicted in FIG. 1. One or more pieces of plywood sheet 100, sheet rock, paneling, lumber, or other materials are obtained. Four foot wide by eight foot long rectangular plywood sheet 100 includes a first end 101, a second end parallel to and spaced apart from end 101, sides 104 and 105, and an intermediate portion 102 extending between said ends. Set screws 41 and 43 are loosened. Member(s) 30 and/or 31 are slid outwardly away from one another such that the distance indicated by arrows J is greater than four feet. Sheet 100 is placed in the bed of a pickup truck in the manner illustrated in FIG. 3 with intermediate portion 102 resting on horizontally oriented members 23 and 24, and with the second end of sheet 100 resting against the corner formed at the juncture or cotermination of wall 54 and floor 50. Gravity acts on sheet 100 and generates a force that act to seat and force the second end in the corner at the cotermination of wall 54 and floor 50. In this manner, the structure of the bed of the truck (i.e., the juncture of the wall 54 and floor 50) assists in preventing the second end from riding up away from floor 50 and in maintaining sheet 100 in the position shown in FIG. 1 on structure 10 and in the bed of the truck. Members 30 and 31 are slid inwardly toward one another until the inner edge of member 32 contacts one side 105 and until the inner edge of member 36 contacts the other side 104 of sheet 100. Set screws 41 and 43 are tightened to secure legs 39 and 33 in position. Set screws 40 and 44 are loosened to permit leg 38A to slide downwardly through member 36 until arm 38 contacts the top of sheet 100 and to permit leg 35 to slide downwardly through member 32 until arm 35 contacts the top of sheet 100. Set screws 40 and 44 are tightened. Panel 100 is secured in position in the bed of the truck and on structure 10. Additional tie-downs can, if desired, be utilized.

FIG. 4 is an enlarged view of a portion of structure 10 and of the truck bed illustrating the use of structure 10 when a plurality of materials are stored and transported using the apparatus and system of the invention.

FIG. 5 illustrates the function of the tailgate or rear wall 54 and the floor of the pickup truck bed in securing panel material 90 in the bed of a pickup truck. The weight of panel material 90 generates a force X that has components X1 and X2 that act against the tailgate 54 and floor 50, respectively, of the truck and function to prevent end 90 from moving upwardly away from floor 50.

Having described my invention in such terms as to enable those of skill in the art to make and practice it, and having described the presently preferred embodiments thereof, I claim:

1. A storage and transport system comprising
(a) a truck including
(i) a cab,
(ii) a bed with a floor, forward wall, side walls, and a tailgate, each of said walls and said floor coterminating to form a corner extending along said bed, and
(iii) wheel wells extending at least in part into said bed;
(b) an auxiliary support structure secured to and extending upwardly from said bed and including at least one support member having a horizontally oriented support surface positioned above said floor and intermediate said tailgate and said forward wall;
(c) at least one elongate canted piece of transport material extending over said horizontally oriented support surface, said piece of material having a first end, a second end lower than said first end, and an intermediate portion extending between said first and second ends, a section of said intermediate portion contacting and supported by said horizontally oriented support surface;
said support structure being shaped and dimensioned and positioned in said bed such that
(d) said first end extends upwardly over said cab;
(e) said second end is positioned in said corner adjacent said tailgate and said floor such that the force of gravity acting on said piece of material forces said second end against said tailgate and said tailgate acts to prevent said second end from moving upwardly away from said floor.

2. A storage and transport system comprising
(a) a truck including
(i) a cab,
(ii) a bed with a floor, forward wall, side walls, and a tailgate, each of said walls and said floor coterminating to form a corner extending along said bed, and
(iii) at least a pair of spaced apart wheel wells each extending at least in part from one of said side walls into said bed, each of said wheel wells having a vertically oriented inner wall (81) extending upwardly from said floor and spaced apart from said side walls;
(b) an auxiliary support structure secured to and extending upwardly from said bed and including
(i) at least one support member including a horizontally oriented support surface,
(ii) a pair of feet each secured to a different one of said inner walls of said wheel wells; and,
(c) at least one elongate canted piece of transport material extending over said horizontally oriented support surface, said piece of material having a top, a bottom, a first end, a second end, and an intermediate portion extending between said first and second ends, a section of said intermediate portion contacting and supported by said horizontally oriented support surface;
said support structure being shaped and dimensioned and positioned in said bed such that
(d) said first end extends over said cab; and,
(e) said second end is lower than said first end and contacts said tailgate.

3. A storage and transport system comprising
(a) a truck including
(i) a cab,
(ii) a bed with a floor, forward wall, side walls, and a tailgate, each of said walls and said floor coterminating to form a corner extending along said bed, and
(iii) at least a pair of spaced apart wheel wells extending at least in part into said bed;
(b) an auxiliary support structure secured to and extending upwardly from said bed and including
(i) at least one support member having a horizontally oriented support surface and adjustable to extend from one of said wheel wells to the other of said wheel wells,
(ii) a pair of feet, each secured to said bed,
(iii) at least one horizontally adjustable member extending laterally from said support member to supplement the length of said horizontally oriented support surface;
(iv) a vertically adjustable member extending upwardly from said horizontally adjustable member and including a horizontally oriented containment arm;
c) at least one elongate canted piece of transport material extending over said horizontally oriented support surface, said piece of material having a top, a bottom, a first end, a second end, and an intermediate portion extending between said first and second ends, a section of said intermediate portion contacting and supported by said horizontally oriented support surface, said vertically adjustable member positioned such that said containment arm contacts said top to secure said piece of material in place;
said support structure being shaped and dimensioned and positioned in said bed such that
(d) said first end extends over said cab; and,
(e) said second end is lower than said first end and contacts said tailgate.

4. The storage and transport system of claim 1 wherein said support member extends between said wheel wells.

5. The storage and transport system of claim 2 wherein said support member extends between said wheel wells.

6. The storage and transport system of claim 1 wherein
(a) each of said wheel wells has a vertically oriented inner wall (81) extending upwardly from said floor and spaced apart from said side walls; and,
(b) said auxiliary support structure includes feet each secured to one of said inner walls.

7. The storage and transport system of claim 3 wherein
(a) each of said wheel wells has a vertically oriented inner wall (81) extending upwardly from said floor and spaced apart from said side walls; and,
(b) said feet are each secured to a different one of said inner walls.

8. The storage and transport system of claim 1 wherein said Piece of transport material extends only over said bed and said cab.

9. The storage and transport system of claim 2 wherein said piece of transport material extends only over said bed and said cab.

10. The storage and transport system of claim 3 wherein said piece of transport material extends only over said bed and said cab.

11. The storage and transport system of claim 6 wherein said support member folds downwardly onto said floor with said feet secured to said inner walls.

12. The storage and transport system of claim 7 wherein said support member folds downwardly onto said floor with said feet secured to said inner walls.

13. The storage and transport system of claim 2 wherein said support member folds downwardly onto said floor with said feet secured to said inner walls.
